(19) United States
(12) Patent Application Publication
(10) Pub. No.: US 2005/0127209 A1
(43) Pub. Date: Jun. 16, 2005

(54) Director plate having smooth exits

(76) Inventors: Milind V. Phadke, Rochester, NY (US); Paul S. Von Bacho, Rochester, NY (US); Julie M. Galante-Fox, Hemlock, NY (US)

Correspondence Address: DELPHI TECHNOLOGIES, INC., M/C 480-410-202, PO BOX 5052, TROY, MI, 48007, US

(21) Appl. No.: 10/737,354

(22) Filed: Dec. 16, 2003

(51) Int. Cl. F02M 61/10

(52) U.S. Cl. 239/533.11; 239/596; 239/585.1

(57) ABSTRACT

A director plate for a fuel injector for use in an internal combustion engine. A plurality of fuel passages extend through the plate between an inlet surface and an exit surface. The passage and exit surfaces are extremely smooth, having an average surface roughness (Rₐ) less than about 0.2 μm, and preferably less than about 0.1 μm. The corners of the exits are sharp and are free of features such as break-edges, burrs, and remelt. The surface quality may be obtained via any means of surface finishing.

### TECHNICAL FIELD

The present invention relates to fuel injectors for internal combustion engines; more particularly, to fuel injectors for injection of fuel into the cylinders of such engines; and most particularly, to such a fuel injector including a director plate having fuel passage exits with minimal raised rims, burrs, and break-edges.

### BACKGROUND OF THE INVENTION

Fuel injected internal combustion engines are well known. In such an engine, the injection tip of the fuel injector is positioned forward of the intake valve and includes a perforated plate, known in the art as a “director plate,” for dispersing and directing fuel injected from the injector toward the intake valve of the combustion chamber. As is well known in the automotive arts, the configuration and positioning of a director plate with respect to the injector tip and the combustion chamber intake valve are critical elements in the distribution of fuel into the combustion chamber. For example, a director plate may have a plurality of fuel passages therethrough, and the axes of the passages may be inclined radially and/or tangentially from the axis of the director plate. Director plates, including fuel passages, are formed typically of a stainless steel as by precision stamping from sheet stock. Other forming processes for fuel passages are known, such as electrical discharge machining (EDM), laser drilling, and the like; however, stamping is an inexpensive and generally accepted process for forming fuel passages in director plates.

A known problem can arise during use of fuel injectors equipped with director plates, and especially stamp-formed director plates. Such director plates can accumulate deposits of fuel-related materials around the exits of the fuel passages, both on the surface of the plates and along the passage walls adjacent the exits. Such deposits are undesirable, can affect the spray pattern of fuel, and can grow large enough to cause a fuel injector to fail due to flow restriction. If the injector cannot be cleaned, the only practical remedy is replacement of the fuel injector, which is inconvenient, time-consuming, and expensive.

What is needed in the art is a fuel injector having a director plate that does not readily accumulate fuel-related deposits around the exits of the fuel passages.

It is a principal object of the present invention to provide a fuel injector having a director plate that does not readily accumulate fuel-related deposits around the exits of the fuel passages.

### SUMMARY OF THE INVENTION

Briefly described, a director plate for a fuel injector in accordance with the invention includes a plurality of fuel passages extending therethrough between an inlet surface and an exit surface of the director plate. The passage and exit surfaces are extremely smooth, having an average surface roughness (Rₐ) less than about 0.2 μm, and preferably less than 0.1 μm. The corners of the exits are sharp and are free of features such as break-edges, burrs, and remelt. The surface quality may be obtained via any means of surface finishing, and the invention is defined by the quality of the surfaces and not by the means of attaining such quality.

### BRIEF DESCRIPTION OF THE DRAWINGS

The present invention will now be described, by way of example, with reference to the accompanying drawings, in which:

FIG. 1 is an elevational cross-sectional view of a portion of a fuel injector including a director plate;

FIG. 2 is an enlarged cross-sectional view of the director plate shown in FIG. 1;

FIG. 3 is an enlarged view of the area shown in Circle 3 in FIG. 2, showing a fuel passage in accordance with the invention;

FIG. 4 is a view like that shown in FIG. 3, showing a prior art fuel passage and exit having stamping-residual passage damage and raised exit rim;

FIG. 5 is a view like that shown in FIG. 4, showing the beginning of accumulation of fuel-related deposits around the raised exit rim;

FIG. 6 is a view like that shown in FIG. 5, showing severe accumulation of fuel-related deposits around the raised exit rim; and

FIG. 7 is a topological schematic drawing of an idealized crystal surface showing relative preference of material adsorption sites.

### DESCRIPTION OF THE PREFERRED EMBODIMENTS

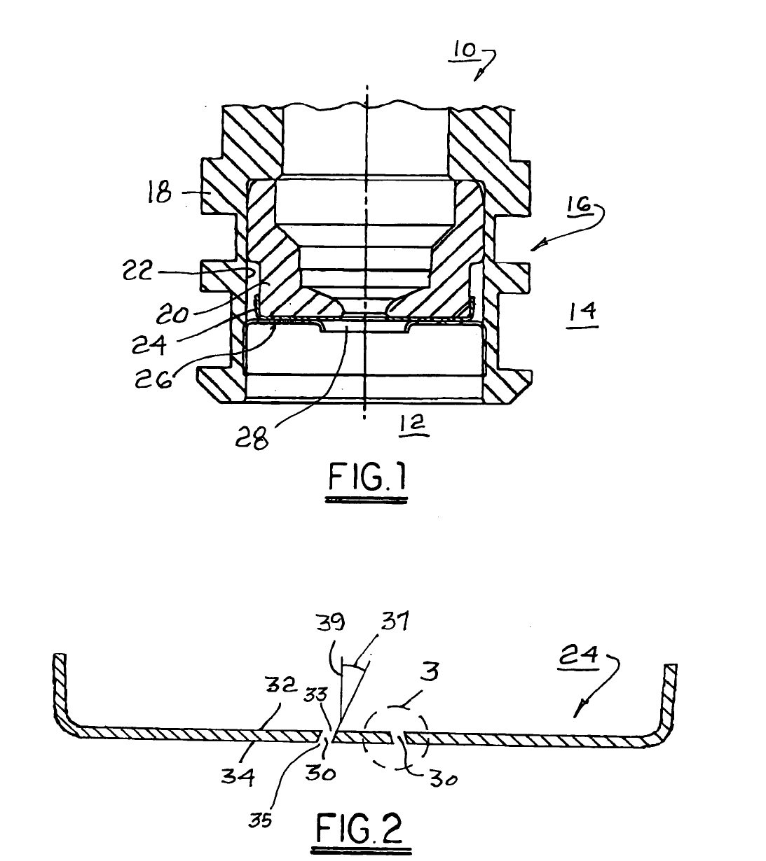

Referring to FIGS. 1 and 2, there is shown a fuel injector 10 for use in injecting fuel at the intake valve 12 of an internal combustion engine 14. An end portion 16 of injector 10 includes an injector body 18 surrounding an injector nozzle 20 press-fit into a bore 22 in body 18. A director plate 24, formed as a shallow cup, is disposed on the end of nozzle 20 and retained in place by a retainer 26 also pressed into bore 22. A central opening 28 in retainer 26 permits fuel to be injected from director plate 24 into chamber 12. Plate 24 includes a plurality of passages 30 therethrough between a fuel inlet surface 32 and a fuel exit surface 34, the passages having respective fuel inlets 33 and exits 35. Plate 24 is formed typically by stamping from sheet stock of a stainless steel such as AISI 430 or 304L. The sheet stock typically has a thickness of about 0.150-0.200 μm, and the passages have a comparable diameter, in the range of about 0.150-0.300 μm, depending in part upon the number of passages selected. Passages are stamped in the direction 36 from inlet surface 32 through exit surface 34, which is also the fuel flow direction. The axes of the passages typically are inclined by an angle 37 from the surface normal 39, typically about 190, which incline may be radial, tangential, or both, from the axis of the plate and injector.

Referring now to FIGS. 4 through 6, a prior art director plate 24 that is formed by stamping typically exhibits distortion and tearing of the metal structure of the passage walls 41, especially near the exit side of the punching. Such distortion is known in the art as “break-edge” 38. Further, punching is known to leave a slight raised, irregular rim 40 around the exit opening 42 (FIG. 4). Heretofore, these artifacts of punching have been considered in the art to be trivial and of no practical consequence. However, we have found surprisingly that they are of great importance in the premature impairment and eventual failure of fuel injectors. Examinations of prior art director plates 24 after periods of use show that burrs and crevices in and adjacent to rim 40 are sites for accumulation of fuel-related deposits 44 (FIG. 5). With continued plate use, these deposits can continue to grow to a size 44′ (FIG. 6) sufficient to cause the fuel injector to fail to deliver its intended volume and spray pattern of fuel into the combustion chamber.

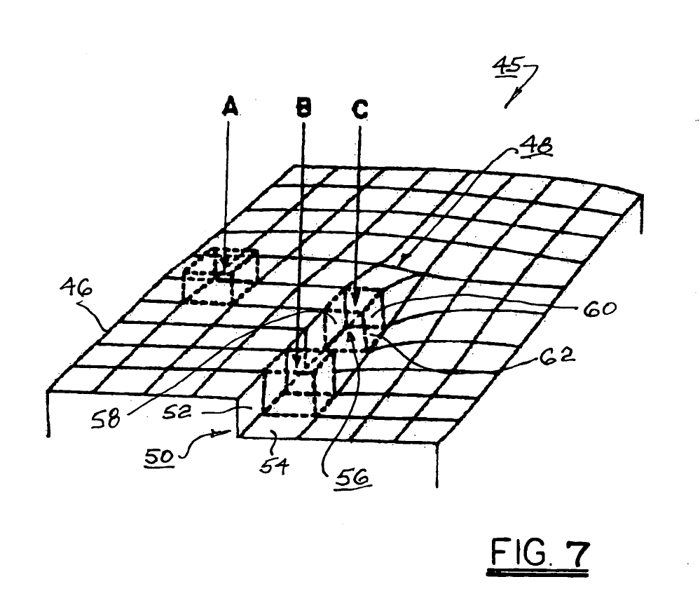

The tendency for deposits to form on rough surfaces and break-edges can be explained in terms of preferred adsorption sites on a crystal surface. While not essential to the invention, the following theory is offered to explain the success of the invention. Referring to FIG. 7, a topological schematic drawing 45 of an idealized crystal surface 46 is shown. Surface 46 includes a discontinuity 48 such as would result from formation of break-edge 38 and rim 40 (FIG. 4). Discontinuity 48 results in a ledge 50 having two walls 52,54, and a corner 56 having three walls 58,60,62. Particle A is deposited on surface 46 and has only one side in contact therewith. Particle B is deposited on ledge 50 and thus has two sides in contact with walls 52 and 54. Particle C is deposited in corner 56 and thus has three sides in contact with walls 58 and 60 and 62. Because particles are bonded to substrates by the total surface energy available, Particle C will be adsorbed more strongly than Particle B, which will be more strongly adsorbed than Particle A. Therefore, fuel-related deposits are seen to form most readily on surfaces including corners and ledges, which are constituents of any rough surfaces such as break-edges 38 and burred rim 40.

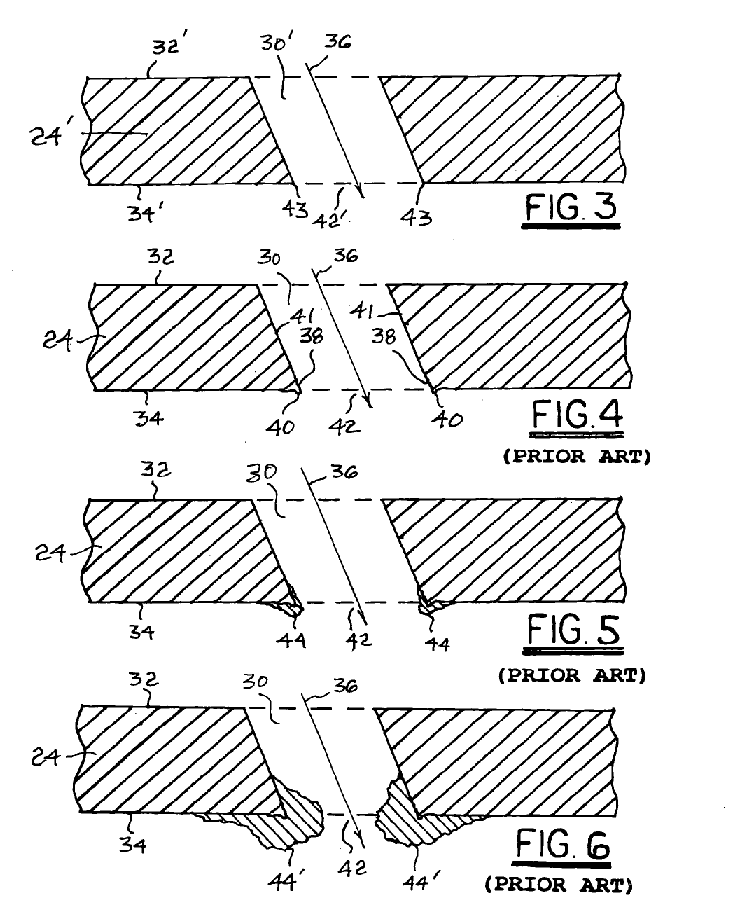

What is now recognized by the inventors is that surface roughness in the vicinity of passage exit opening 42 is very critical to formation of deposits, and therefore, smoother surfaces in these regions are highly desirable. Referring to FIG. 3, an improved director plate 24′ in accordance with the invention is substantially free of significant roughness in regions in and around passage exit opening 42′ of passage 30′, and especially at passage exit corner 43. “Significant roughness” is defined herein as being a surface having a numerical roughness average (Rₐ) less than about 0.2 μm, and preferably less than about 0.1 μm, where Rₐ is the arithmetic mean of the departures of the roughness profile from the mean line. Such levels of smoothness can be achieved by any of several well-known means, including but not limited to mechanical polishing, magnetorheological finishing, and laser polishing. The scope of the invention is not limited by any selected means of surface smoothing, including initially forming passages having no break-edge and/or rim deformation.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

1. A director plate for use in a fuel injector for an internal combustion engine, the plate having fuel inlet and fuel exit surfaces and having at least one passage, said at least one passage having a passage wall formed between said inlet and exit surfaces for conduction of fuel through the plate between a passage inlet and a passage exit of said at least one passage, wherein a numerical surface roughness of said exit surface adjacent said passage exit of said at least one passage is less than about (Rₐ) 0.21 μm.

2. A director plate in accordance with claim 1 wherein said numerical surface roughness is less than about (Rₐ) 0.1 μm.

3. A director plate in accordance with claim 1 wherein the numerical roughness of said passage wall adjacent said passage exit of said at least one passage is less than about (Rₐ) 0.2 μm.

4. A director plate in accordance with claim 3 wherein said numerical surface roughness is less than about (Rₐ) 0.1 μm.

5. A director plate in accordance with claim 1 wherein a juncture between said passage wall and said fuel exit surface defines an exit corner and wherein a numerical surface roughness of said exit corner is less than about (Rₐ) 0.2 μm.

6. A director plate in accordance with claim 5 wherein the numerical surface roughness of said exit corner is less than about (Rₐ) 0.1 μm.

7. A fuel injector for use in an internal combustion engine, said fuel injector comprising a director plate having fuel inlet and fuel exit surfaces and having at least one passage, said at least one passage having a passage wall formed between said inlet and exit surfaces for conduction of fuel through the plate between a passage inlet and a passage exit of said at least one passage, wherein a numerical surface roughness of said exit surface adjacent said passage exit of said at least one passage is less than about (Rₐ) 0.2 μm.

8. A fuel injector in accordance with claim 7 wherein the numerical roughness of said passage wall adjacent said passage exit of said at least one passage is less than about (Rₐ) 0.1 μm.

9. A fuel injector in accordance with claim 7 wherein a juncture between said passage wall and said fuel exit surface defines an exit corner and wherein a numerical surface roughness of said exit corner is less than about (Rₐ) 0.21 μm.

10. A fuel injector in accordance with claim 9 wherein the numerical surface roughness of said exit corner is less than about (Rₐ) 0.1 μm.

11. A director plate for use in a fuel injector for an internal combustion engine, the plate having fuel inlet and fuel exit surfaces and having at least one passage, said at least one passage having a passage wall formed between said inlet and exit surfaces for conduction of fuel through the plate between a passage inlet and a passage exit of said at least one passage, wherein a numerical surface roughness of said passage wall adjacent said passage exit of said at least one passage is less than about (Rₐ) 0.2 μm.

12. A director plate in accordance with claim 11 wherein said numerical surface roughness is less than about (Rₐ) 0.1 μm.

13. A director plate for use in a fuel injector for an internal combustion engine, the plate having fuel inlet and fuel exit surfaces and having at least one passage, said at least one passage having a passage wall formed between said inlet and exit surfaces for conduction of fuel through the plate between a passage inlet and a passage exit of said at least one passage, wherein a juncture between said passage wall and said fuel exit surface defines an exit corner and wherein a numerical surface roughness of said exit corner is less than about (Rₐ) 0.2 μm.

14. A director plate in accordance with claim 13 wherein said numerical surface roughness is less than about (Rₐ) 0.1 μm.

15. An internal combustion engine comprising a fuel injector including a director plate having fuel inlet and fuel exit surfaces and having at least one passage, said at least one passage having a passage wall formed between said inlet and exit surfaces for conduction of fuel through the plate between a passage inlet and a passage exit of said at least one passage, wherein a numerical surface roughness of said exit surface adjacent said passage exit of said at least one passage is less than about (Rₐ) 0.2 μm.

16. An internal combustion engine in accordance with claim 15 wherein the numerical roughness of said passage wall adjacent said passage exit of said at least one passage is less than about (Rₐ) 0.1 μm.
